(19) United States
(12) Patent Application Publication
(10) Pub. No.: US 2012/0106149 A1
(43) Pub. Date: May 3, 2012

(54) UNDERWATER AND LANDSCAPE LIGHTING SYSTEM

(75) Inventor: Steve BOA, Montreal (CA)

(73) Assignee: FUSION POOL PRODUCTS INC., Highland Village, TX (US)

(21) Appl. No.: 13/287,723

(22) Filed: Nov. 2, 2011

Related U.S. Application Data
(60) Provisional application No. 61/409,491, filed on Nov. 2, 2010.

(51) Int. Cl. F21V 5/04; F21V 29/00

(52) U.S. Cl. 362/235

(57) ABSTRACT

A lighting system is described. The lighting system includes a substantially round lens, a base, a circuit board and an adaptor. The lens has an exterior side and an interior side. The base has a first side and a second side. The base is sealingly coupled to the interior side of the lens to create a watertight compartment therebetween. The second side of the base has at least one connector member. The circuit board is coupled to the first side of the base. The circuit board implements a circuit including a plurality of light emitting diodes (“LEDs”) and a power supply receiving connector. The power supply receiving connector is accessible through the second side of the base. The adaptor has a first side configured to interface with the at least one connector member and a second side having a threaded coupling to maintain the lighting system in a fixed position in a fitting.

### CROSS-REFERENCE TO RELATED APPLICATIONS

This application claims priority to U.S. Provisional Patent Application No. 61/409,491, filed Nov. 2, 2010, which is incorporated herein by reference in its entirety.

### BACKGROUND OF THE INVENTION

It is frequently desirable to illuminate water-bearing bodies such as swimming pools, spas, hot tubs and fountains from below the water line. In these applications, lighting systems are often installed on and/or in the surfaces of the water-bearing body by coupling the lighting systems to a niche or other fitting. Such niches come in a plurality of sizes to accommodate lighting systems of various sizes. These lighting systems typically include a glass or plastic external lens, one or more lighting elements or light emitters, a circuit board, and one or more components for mounting the lighting system to the surface of the water-bearing body such that the external lens faces into the water-bearing body, and is exposed to the water contained therein. The external lens of such a lighting system typically defines at least a partially water-tight compartment within which the lighting elements are mounted to prevent water from breaching the cavity and causing a short circuit that could cause nearby bathers to be electrocuted.

Operation of such lighting systems causes the lighting elements to generate large amounts of heat. Build up of heat within the lighting system (e.g., from the lighting element(s), microcontroller(s) and any other circuit elements) results in degradation in the performance and longevity of the lighting system. Where the lighting elements are light emitting diodes (“LEDs”), higher operating temperatures may result in the LED elements failing after a shorter operating lifespan. Thus, excess heat must be dissipated from the circuit board. The trend toward brighter lighting systems, using simultaneous combinations of active light elements, as well as the use of higher power light elements, exacerbates the heat problem. While water within the water-bearing body provides some cooling, it is insufficient to properly cool the lighting system because the water is typically still within the water-bearing body. Further, the temperature of the water is typically not sufficiently cold to cool an operating lighting system, especially in warmer climates. Therefore, in order to dissipate the heat generated by the lighting system, a conductive element is often needed. Previously, a heatsink was operatively coupled to the body of the lighting system to conduct the heat away from the circuit board and the lighting elements. However, such heatsinks increase the component and manufacturing cost of the lighting system. In addition, these heatsinks are often relatively large, because they are located within a fitting inside a cavity in the wall of a pool where air and/or water circulation is relatively low. The relatively low circulation of air and/or water in the wall cavity within which the heatsink is mounted require the relatively large heatsink to provide maximum material and surface area to dissipate the heat from the lighting elements.

Accordingly, it is desirable to provide a lighting system that dissipates heat more efficiently than traditional lighting systems and eliminates the need for a heatsink. It is further desirable to provide a lighting system that is easy to install and replace in the water-bearing body by allowing it to be coupled to a standard pool fitting.

### BRIEF SUMMARY OF THE INVENTION

In one preferred embodiment, a lighting system for mounting to a fitting in a pool or to a landscape stake is described. The lighting system includes a lens, a base, a circuit board and an adaptor. The lens has an exterior side and an interior side. The base has a first side and a second side. The base is sealingly coupled to the interior side of the lens to create a watertight compartment therebetween. The second side of the base has at least one connector member. The circuit board is coupled to the first side of the base. The circuit board implements a circuit having a plurality of light emitting diodes (“LEDs”) and a power supply receiving connector. The power supply receiving connector is accessible through the second side of the base. The adaptor has a first side configured to interface with the at least one connector member and a second side having a threaded coupling to maintain the lighting system in a fixed position in a fitting.

In another aspect, a preferred heatsinkless lighting system for mounting to a standard pool fitting and being submerged in water is disclosed. The heatsinkless lighting system includes a curved lens, a base, a circuit board and an adaptor. The curved lens has an exterior side and an interior side. The base is sealingly coupled to the interior side of the curved lens and has one or more connector members. The circuit board is coupled to the base such that the circuit board is sealed between the curved lens and the base. The circuit board implements a circuit comprising a plurality of lighting elements spaced apart from one another on the circuit board to dissipate heat generated by operation of the plurality of lighting elements. The adaptor is configured to mount the heatsinkless lighting system to a standard pool fitting such that the water surrounds the lens and base to dissipate the heat created during use of the plurality of lighting elements. The adaptor has one or more hook members configured to engage with the one or more connector members of the base.

In yet another aspect, a heatsinkless lighting system for mounting to a standard pool fitting and being submerged in water is described. The heatsinkless lighting system includes a lens, a base, a circuit board and an adaptor. The lens is curved and has an exterior side and an interior side. The base has a first side and a second side and is sealingly coupled to the curved lens. The second side of the base has two or more snap connector members and a threaded coupling arranged thereon. The circuit board is coupled to the first side of the base such that the circuit board is sealed between the curved lens and the base. The circuit board implements a circuit comprising a plurality of lighting elements spaced apart from one another on the circuit board to dissipate heat generated by operation of the plurality of lighting elements. The adaptor is configured to mount the heatsinkless lighting system to a standard pool fitting extending from a wall of the pool such that the lens and base are surrounded by water to dissipate the heat from use of the plurality of lighting elements. The adaptor has two or more hook members configured to engage with the one or more snap connector members of the base.

### BRIEF DESCRIPTION OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a rear perspective view of a lighting system in a locked position in accordance with a first preferred embodiment of the present invention;

FIG. 2 is a rear perspective, partially exploded and fragmentary view of the lighting system of FIG. 1 in an unlocked position for mounting in a standard pool fitting;

FIG. 3 is a rear perspective view of the lighting system of FIG. 1 in the locked position mounted with a landscape mounting adaptor or landscape stake;

FIG. 4 is a rear perspective, partially exploded view of the lighting system of FIG. 1;

FIGS. 5A and 5B illustrate a flowchart showing steps for selecting various lighting sequences of the lighting system of FIG. 1;

FIG. 6 is a front elevational view of the circuit board of the lighting system of FIG. 1;

FIG. 7 is a side perspective, partially exploded view of the lighting system of FIG. 1;

FIG. 8 is a front elevational view of a lighting system of a second preferred embodiment of the present invention; and

FIG. 9 is a front elevational view of a heat dissipation plate of the lighting system of FIG. 8.

### DETAILED DESCRIPTION OF THE INVENTION

Certain terminology is used in the following description for convenience only and is not limiting. The words “right,” “left,” “lower,” and “upper” designate directions in the drawings to which reference is made. The words “inwardly” or “distally” and “outwardly” or “proximally” refer to directions toward and away from, respectively, the geometric center or orientation of the device and instruments and related parts thereof. The terminology includes the above-listed words, derivatives thereof and words of similar import.

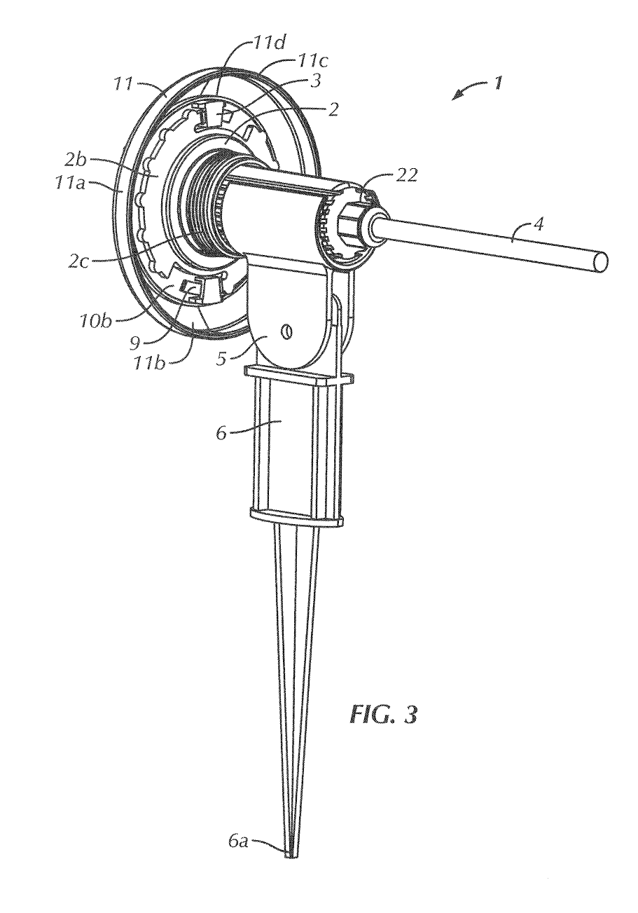

Although the present invention can be used in conjunction with any type of indoor or outdoor application, it is especially suited for underwater lighting applications in connection with pools, spas, baths, fountains, aquariums and the like. Accordingly, the present invention will be described herein with reference to swimming pool applications, particularly for mounting the lighting system to a standard one and one-half inch (1.5″) threaded pool fitting. However, as is shown in FIG. 3, the preferred lighting system of the present application may also be adapted as a landscape lighting system.

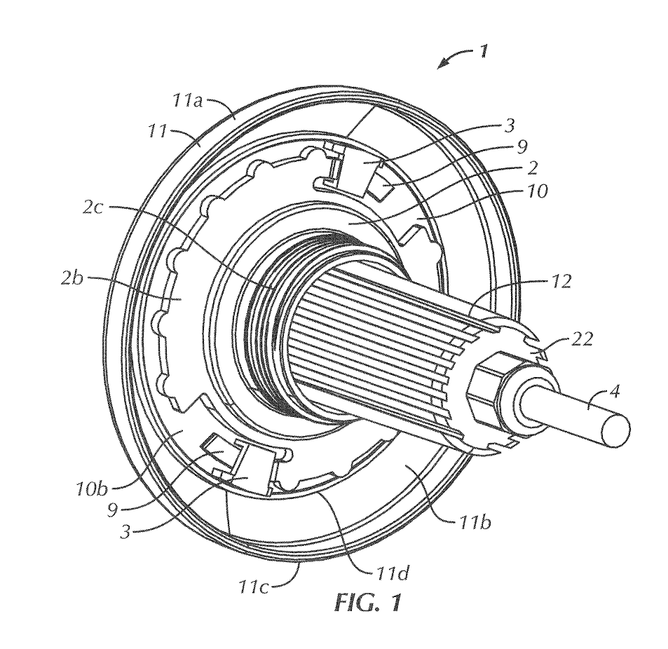

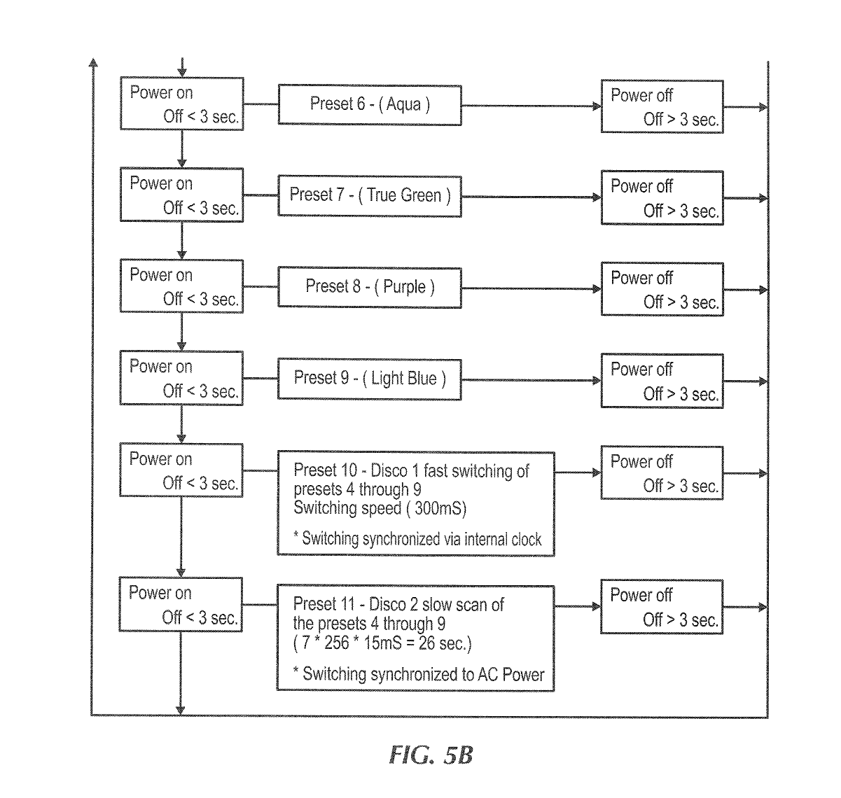

Referring to FIG. 1, a lighting system 1 in accordance with a first preferred embodiment is shown with an adaptor 2 in a locked position against a planar base 10. The lighting system 1 includes the threaded adaptor 2, the planar base 10, a curved lens 11 and an elongated socket 12. A conductor or electrical wire 4 connects the lighting system 1 to a power source (not shown) located at a location remote from the water-bearing body, such as a pool. Preferably, the power source is a twelve (12) Volt A/C power source. In order to generate the twelve (12) Volt source, a remotely located one hundred twenty (120) Volt A/C to twelve (12) Volt A/C transformer may be coupled directly to the standard one hundred twenty (120) Volt A/C line power source. Multiple instances of the lighting system 1 may be powered by a single power source by coupling them to the power source in parallel. In other embodiments, the twelve (12) Volt power source may be replaced by a one hundred twenty (120) Volt A/C power source, a twelve (12) Volt D/C power source or the like. In such cases, appropriate step down or step up circuitry may be necessary to convert the power to a voltage appropriate for the lighting system 1 circuit (FIG. 6). Such step up or step down circuitry may be implemented within the body of or remote to the lighting system 1. The conductor 4 can be any shielded cable or wire suitable for use in wet applications.

The lens 11 of the lighting system 1 has an exterior side 11a and an interior side 11b. The lens 11 is preferably curved to allow the circuit board 20 to be disposed in a compartment created between the lens 11 and the base 10. In the first preferred embodiment, the lens 11 is preferably dome-shaped. However, the lens 11 is not limited to dome-shapes may be any other suitable shape, including planar, oblong, rectangular, polygonal, cubed or the like. The lens 11 may be constructed of different thicknesses. Preferably, the lens 11 has a transparent, semi-transparent or translucent top portion and sidewalls that extend downward from the top portion, terminating at an edge 11c, which is generally circular in shape in the first preferred embodiment, but is not so limited and may take on nearly any shape, such as star, oblong, oval, square, rectangular or nearly any other shape that is desired by the user. The color, shape and thickness of the top portion and the sidewalls of the lens 11 may be varied according to the desired application of the lighting system 1. The interior side 11b of the lens 11 preferably has a second circular edge 11d extending on a plane that is generally parallel to the edge 11c of the sidewalls. The second edge 11d is shaped to maintain the base 10 in a fixed position within the lens 11 and is preferably utilized as a sealing location for insertion of a gasket or like material to provide the sealed compartment for the circuit board 20.

The lens 11 is preferably made of a transparent or semi-transparent plastic material, such as polycarbonate, polycarbonate alloy, optical glass or the like. The material used for the lens 11 allows substantially all the light emitted by lighting elements or light emitting diodes (LED) 16 configured on the circuit board 20 to reach the lens 11 and be emitted into the water 18 in the pool or onto landscaping when the lighting system 1 is adapted for landscape purposes. It is preferable that the selected material(s) for the lens 11 is scratch and dent resistant and that the material does not become cloudy in appearance after prolonged underwater use. Therefore, combinations of materials (e.g., layers and/or coatings) may be applied to the lens 11 in order to, for example, provide the lens 11 with a scratch resistant coating or the like.

The plastic lens 11 may be clear or alternatively, it may be any color that sufficiently transfers light into the water 18 in order to, for example, match the appearance of the lighting system 1 to its surroundings or to provide decorative lighting or light features. In alternate embodiments, the lens 11 may be made of transparent or semi-transparent glass and glass-type materials. In some underwater applications, glass may be preferable over plastic materials due to its higher thermal conductivity. Therefore, glass may provide additional cooling of the lighting system 1 through the external interface between the lens 11 and the water 18 in the water-bearing body.

The base 10 of the lighting system 1 has a first side 10a and a second side 10b and is preferably circular or rounded in shape. The first side or front side 10a of the base 10 preferably supports the circuit board 20 in the assembled configuration. In the first preferred embodiment, the base 10 has a diameter of approximately three inches (3″). However, where additional lighting elements are desired or where a larger or smaller design of the lighting system 1 is preferable, the base 10 (and the lens 11) may be as big as twelve inches (12″) or larger and may be smaller, depending upon user preferences. Regardless the selected diameter of the base 10, it is preferable that the diameter of the base 10 is smaller than the diameter of the lens 11. The second side or rear side 10b of the base 10 has a plurality of snap connector members 3 arranged thereon, specifically two (2) snap connector member 3 in the first preferred embodiment. Each of the snap connector members 3 preferably has a channel for accepting a hook member 9 of an adaptor 2 when the adaptor 2 is in the locked position.

While the lighting system 1 will be shown with the two (2) preferred snap connector members 3, arranged at opposite ends of the base 10, less or more snap connector members 3 may be arranged on the lamp base 10. While the snap connector members 3 are preferably at opposite ends of the base 10, they may also be positioned at different points on the base 10 without departing from the scope of this invention. Further, though snap connector members 3 are preferred, other types of connectors and fasteners may be used to removably couple the adaptor 2 to the base 10. Such connectors and fasteners may include hook and loop materials, clamps, adhesives, spikes, screws or other related connectors and fasteners to releasably secure the base 10 to the adaptor 2 and are within the scope of this invention. In other embodiments, the adaptor 2 may be coupled directly to the lens 11 instead of or in addition to the base 10. For example, a plurality of bolts or other fasteners may be used to couple the lens 11 to the adapter 2 at a plurality of through holes. Similarly, the snap connector members 3 may be arranged on the inside of the lens 11 instead of or in addition to the base 10.

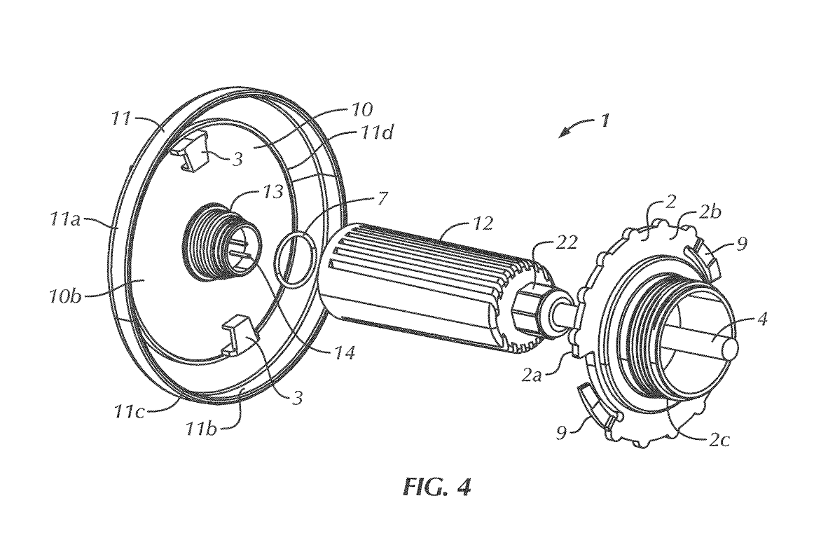

Referring now to FIG. 4, the second side 10b of the base 10 also includes a threaded coupling 13 for engaging the elongated socket 12. In the first preferred embodiment, the threaded coupling 13 has a three quarter inch (¾″) conduit thread, but other types and sizes of threads and connectors may be implemented to couple the base 10 with the elongated socket 12 without departing from the scope of this invention. The elongated socket 12 is preferably constructed of a non-conductive material, such as plastic or polyvinyl chloride (“PVC”) and has a hollow channel therein. A first end of the elongated socket 12 accepts the conductor 4 and includes a cable grommet and/or a cable nut 22 for releasably fixing the conductor 4 in the elongated socket 12 and for creating a generally watertight pressure fit within the elongated socket 12. The second end of the elongated socket 12 is threaded to engage with the threaded coupling 13. An o-ring 7 is preferably applied to the threaded coupling 13 to prevent water from permeating the lighting system 1 through the coupling between the threaded coupling 13 and the elongated socket 12. A second o-ring (not shown) may also be positioned at the terminal edge of the second end of the elongated socket 12. As a result, when the elongated socket 12 is coupled to the base 10, the lighting system 1 is substantially watertight.

The conductor 4 passes through the second (threaded) opening of the elongated socket 12 into the hollow channel. One or more power supply pins 14 of the circuit board 20 are accessible through an opening in the second side 10b of the base 10. The power supply pins 14 couple the components of the circuit implemented on the circuit board 20 to the power supply via the conductor 4. Preferably, the power supply pins 14 are accessible through an opening or void in the middle of the threaded coupling 13. Thus, when the elongated socket 12 is coupled to the base 10 by the threaded coupling 13, water will not be able to reach the connection between the power supply pins 14 and the conductor 4.

The connection between the power supply pins 14 and the conductor 4 is preferably made by a DC barrel connector (not shown) at the terminal end of the conductor 4. The power supply pins 14 are arranged in a DC connector jack and the DC barrel connector is plugged into the circuit board 20 using the DC connector jack. The DC barrel connector allows the lighting system 1 to be easily unplugged from the conductor 4 for performing repairs, upgrades, replacements and the like. However, other connectors for coupling the lighting system 1 to a remote power supply, such as the MR-16 connector, may be used without departing from the scope of this invention.

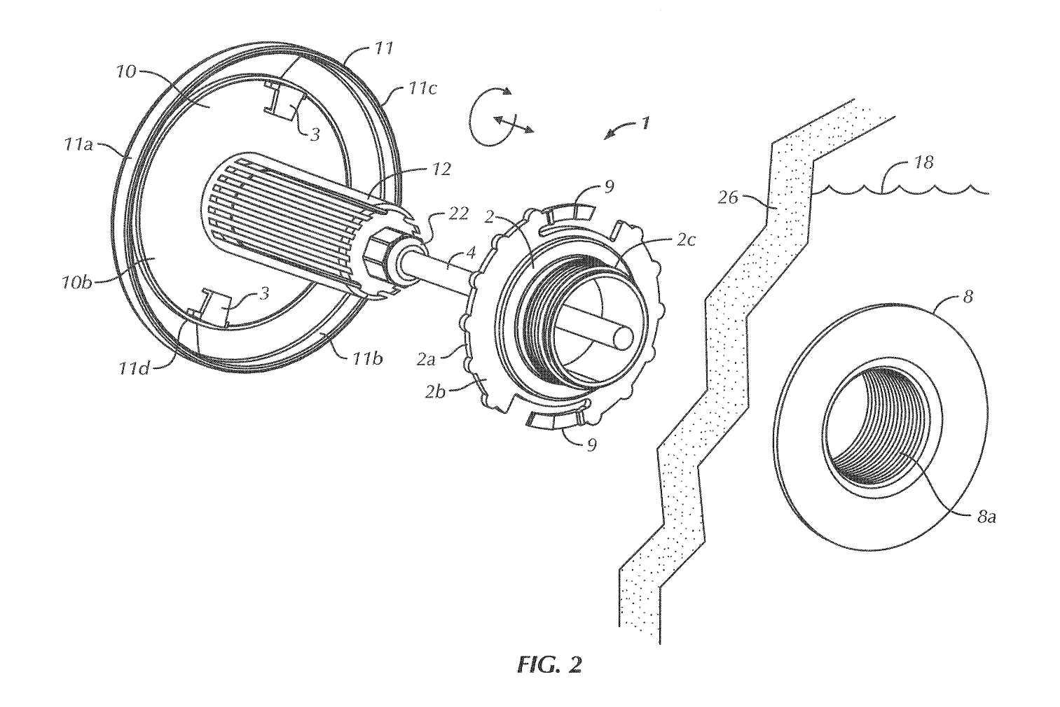

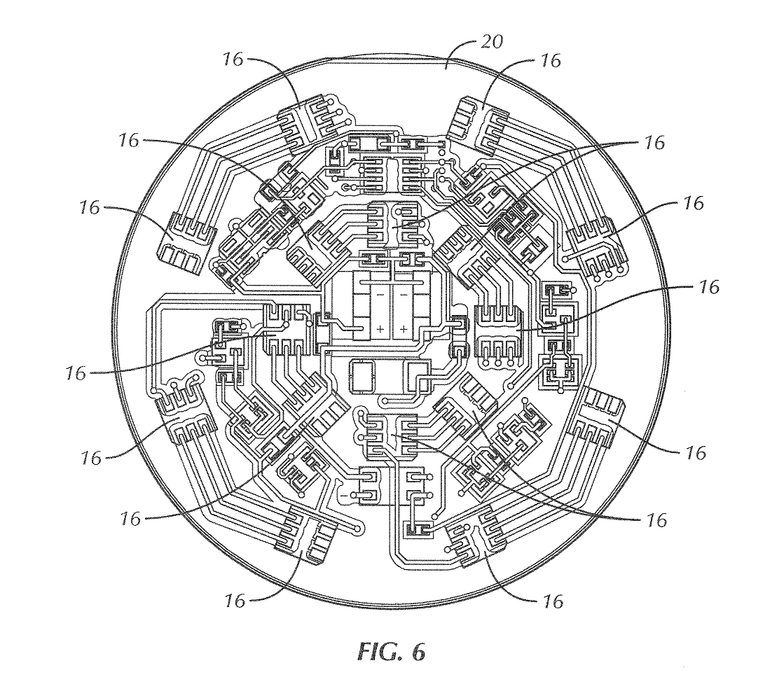

Referring now to FIGS. 2 and 7, the circuit board 20 is mounted to the first side 10a of the base 10 using an adhesive, fasteners or other like attachment mechanisms. Preferably, a heat transferring material is applied between the circuit board 20 and the base 10 in order to facilitate the transfer of heat from the circuit board 20 to the base 10 and to the water 18 in the water-bearing body. As shown in FIG. 7, when the base 10 is coupled with the lens 11, a compartment for the circuit board 20 is formed. A waterproof sealant sealably couples the edge of the base 10 to the lens 11 at the second edge 11d within the lens 11 such that the created compartment is watertight to prevent water 18 from accessing the created compartment and short circuiting the circuit board 20. A short circuit within the circuit board 10 could create a hazard to nearby bathers by introducing the current flowing through the circuit of the lighting system 1 into the water 18 within the water-bearing body.

Referring now to FIG. 6, the circuit arranged on the circuit board 20 is shown. Sixteen (16) lighting elements 16 are shown arranged on the circuit board 20 of the first preferred embodiment in a pattern of two concentric circles, each of the concentric circles having eight (8) LEDs 16. However, any other number of lighting elements 16 may be arranged on the circuit board 20. For example, the circuit board 20 may alternatively include twenty-four (24) lighting elements 16. Preferably, the lighting elements 16 are light emitting diodes 16, but the lighting elements 16 may also be halogen bulbs, neon lights and/or the like. The arrangement of the lighting elements 16 on the circuit board 20 is sufficiently spaced out to minimize heat transfer and heat generation by and between the light elements 16 or, generally to limit hot spots on the circuit board 20 by closely spaced lighting elements 16.

In the first preferred embodiment, the lighting elements 16 are separately controllable to emit red, green and/or blue light. Thus, any individual lighting element 16 may be illuminated or a combination of lighting elements 16 may be illuminated simultaneously to produce various colors and intensities of light, including white light. In another embodiment, the lighting elements 16 on the circuit board 20 are arranged in arrays of multiple lighting elements 16. In this configuration, each array is separately controllable from each other array. The arrays may similarly be illuminated individually or in combinations to produce various colors and intensities of light.

The circuit board 20 of the first preferred embodiment further includes a plurality of analog and/or digital circuit elements, such as capacitors, resistors, inductors, diodes and/or integrated circuits electrically coupled in operative arrangement for illuminating the LEDs 16. The arrangement of the LEDs 16 and other circuit elements on the circuit board 20 is such that heat generation between or from lighting element 16 to lighting element 16 and to the other circuit components is substantially reduced. Thus, the need for a conductive element such as a heatsink to dissipate heat away from the circuit board 20 is greatly reduced or eliminated. The heat reducing layout of the circuit board 20 allows for the elongated socket 12 to be constructed from a non-conductive material, as described above. While FIG. 6 demonstrates one particular layout of the lighting elements 16 on the circuit board 20, other layouts, having more or less lighting elements 16 may be implemented on the circuit board 20 without departing from the scope of this invention. Further, the particular arrangement of the lighting elements 16 in FIG. 6 may be altered or modified so long as the heat dissipating properties of the layout are retained.

Referring to FIGS. 1 and 2, the first preferred lighting system 1 is shown in FIG. 2 in an unlocked position for mounting in the standard pool fitting 8. The sealed assembly, including the lens 11, base 10, circuit board 20 and elongated socket 12 is configured to interface with an adaptor 2 that has a locked position and an unlocked position. A front side 2a of the adaptor 2 is configured to interface with the second side 10b of the base 10 by a plurality of elongated hook members 9 arranged at the periphery of the adaptor 2. Preferably, the hook members 9 are disposed at opposite ends of the adaptor 2 such that they may simultaneously engage with the snap connector members 3 of the base 10.

In the locked position of FIG. 1, the hook members 9 are engaged with the snap connector members 3 by the adaptor 2 being twisted against the lamp base 10 until the hook members 9 fully engage with and snap into the snap connectors 10. Preferably, the snap connector members 3 are slightly undersized relative to the hook members 9 to create a pressure fit between these elements in the locked position and to therefore prevent the lighting system 1 from becoming unlocked.

In the locked or unlocked position, the adaptor 2 may be threadably engaged with the standard pool fitting 8 using a threaded coupling 2c on the rear side 2b of the adaptor 2. As shown in FIG. 2, the lighting system 1 is preferably mounted to the standard pool fitting 8 by threading the threaded coupling of the unlocked adaptor 2 onto the fitting 8. The arrangement of the hook members 9 and the snap connector members 3 simplifies installation of the lighting system 1 in the standard pool fitting 8 of a water-bearing body, preferably a pool or spa, and improves circulation of water 18 in the water-bearing body around the lens 11, thereby cooling the LEDs 16 arranged on the circuit board 20. Specifically, the lighting system 1 generally extends from a wall 26 of the pool such that water envelopes the exterior surface 11a of the lens 11 and the second side 10b of the base 10. The water 18 in the pool generally circulates in the pool such that the circulation is able to provide forced conductive and/or convective heat transfer of heat generated from the LEDs 16 and dissipate heat from the circuit board 20. Accordingly, exposing or extending the lighting system 1 from the side of the wall at least slightly into the water 18 in the pool provides assistance with dissipating heat from the lighting system 1 of the preferred embodiments.

Preferably, the standard pool fitting 8 is a standard one and one-half inch (1.5″) pool fitting having a plurality of threads 8a. The fitting 8 is mounted in the wall or other surface 26 of the water-bearing body, such as a pool, spa or hot tub. A threaded coupling 2c of the adaptor 2 is twisted along the threads 8a into the fitting 8 until the adaptor 2 and the fitting 8 are tightly coupled with one another. One end of the conductor 4 is guided through the adaptor 2 and the fitting 8 to the remote power supply, while the other end of the conductor 4 is electrically coupled to the lighting system 1, as described above. Once the adaptor 2 is threadably coupled to the fitting 8 and the conductor 4 is electrically coupled to the lighting system 1, the remaining portion of the lighting system 1 is coupled to the adaptor 2 by engaging the hook members 9 with the snap connector members 3 to place the lighting system 1 into the locked position. When the lighting system 1 is mounted to the fitting 8, the elongated socket 12 and the conductor 4 pass through the fitting 8 and into the surface of the water-bearing body.

Referring to FIG. 3, an illustration of a rear perspective view of the lighting system 1 of the first preferred embodiment adapted for use in a landscaping application is shown. The adaptor 2 is in the locked position against the body 10, thereby making the lighting system 1 watertight. A landscape mounting bracket 5,6 is coupled to the lighting system 1 for use in a variety of outdoor applications. The landscape mounting bracket 5, 6 includes a rotating bracket 5, having a first opening arranged to be coupled with the elongated socket 12. Preferably, the opening of the rotating bracket 5 is sized so as to create a pressure fit with the elongated socket 12. When the elongated socket 12 passes through the opening of the rotating bracket 5, the rotating bracket 5 expands, allowing the elongated socket 12 to pass into the opening. Once the elongated socket 12 is in the opening of the rotating bracket 5, the rotating bracket 5 contracts to hold the lighting system 1 in place. The rotating bracket 5 is arranged to be pivotably coupled to a stake 6. The stake 6 includes a pointed, elongated portion 6a for placing the lighting system 1 in a permeable or semi-permeable surface such as grass, dirt, mulch and/or the like. In alternate applications, other configurations of the stake 6 may be utilized. For example, the stake 6 may be replaced with a stand having a wide base for movably positioning the lighting system 1 on a flat surface.

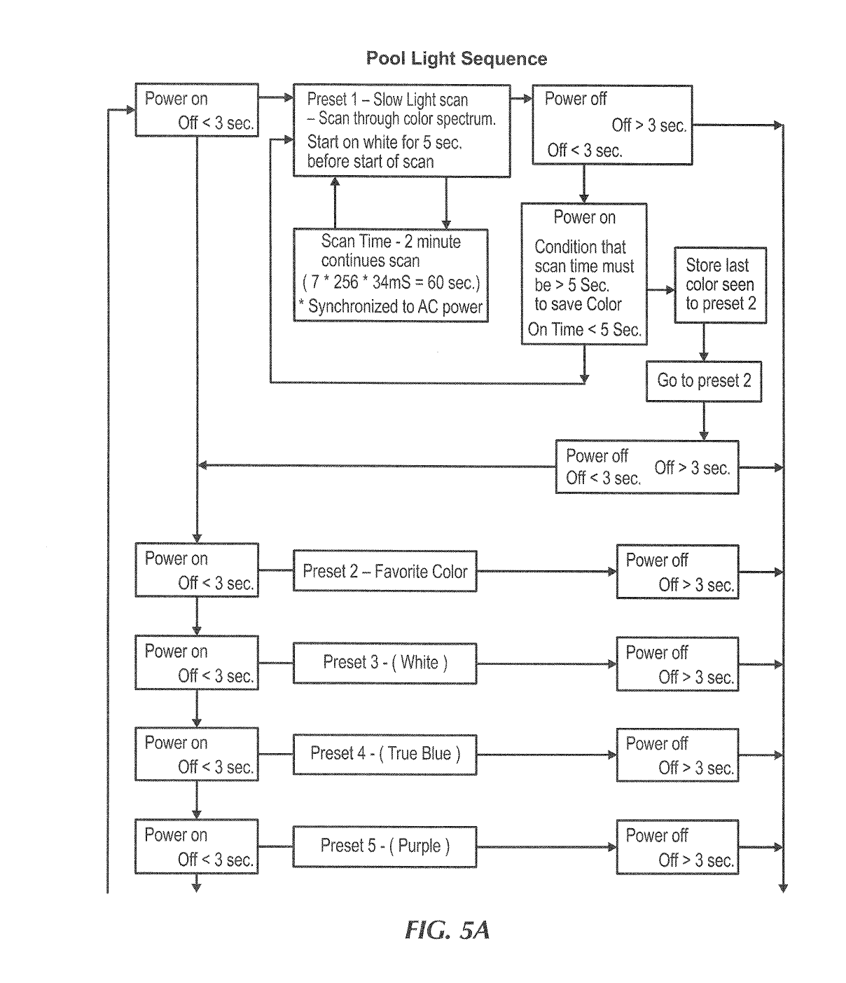

Referring to FIGS. 5A and 5B, operation of the lighting system 1 will be described according to a plurality of preset programs. FIGS. 5A and 5B illustrate a flowchart for operating and selecting various lighting sequences of the lighting system 1 of the first preferred embodiment. When electrical power to the lighting system 1 is applied, a timer begins counting to three seconds (3 s). If the power is deactivated before the timer reaches three seconds (3 s), on the next power on, the lighting system 1 will enter the next available program mode. Thus, a user can cycle through the available program modes by pulsing the power supplied to the lighting system 1 the number of times necessary to reach a desired program mode. For example, if the user would like to enter preset five, the user would turn the power on-off-on-off-on-off-on-off-on, with each power on being for less than three seconds (3 s). Once a preset mode is entered, when power is deactivated for more than three seconds (3 s) in any of the preset modes, the lighting system 1 returns to the initial state at preset one. The counting or lag time is not limited to three seconds (3 s) and may be nearly any predetermined time period selected by the user and/or designer of the lighting system 1. Each of the preset program modes will now be described in more detail.

When power to the lighting system 1 is applied for more than three seconds (3 s) in the initial state, a first preset program is enabled. The first preset program slowly scans, for example, two minutes (2 min) per color through the color spectrum available to the lighting system 1. The scan starts at the color white for preferably five seconds (5 s) in order to determine whether the user is attempting to save a favorite color, as detailed later. After five seconds (5 s), the light elements 16 of the lighting system 1 change colors every two minutes (2 min), synchronized to AC power. While in the first preset, if the power to the lighting system 1 is deactivated for less than three seconds (3 s) and then reapplied, the lighting system determines whether the last color presented should be saved as a “favorite color.” If the scan time prior to the power being deactivated was less than five seconds (5 s), the lighting system 1 reenters the first preset and does not save a favorite color. However, if the scan time was greater than five seconds (5 s), the last color displayed by the lighting system 1 is saved as the favorite color and the lighting system 1 enters the second preset program. In the second preset, the saved favorite color is displayed constantly. The third through ninth presets cycle through the available colors in the following order: White, True Blue, Purple, Aqua, True Green, Purple and Light Blue. The tenth preset is a first disco mode that switches through the presets 4 through 9 at a switching speed of three hundred milliseconds (300 ms), while the eleventh preset is a second disco mode that scans through the presets four through nine (4-9) at a switching speed of approximately fifteen milliseconds (15 ms). While one example of the preset programs for the lighting system 1 has been described with reference to FIGS. 5A and 5B, other presets may be stored as well. For example, presets three through nine (3-9) could be placed in a different order or if possible, they may be programmed to display different colors. In addition, more or less presets may be available than the eleven (11) presets described herein. For example, an additional preset may synchronize the lighting system 1 to playing music.

In order to implement the various presets described above, one or more controllers may be coupled to the lighting system 1. For example, a Digital Multiplex (“DMX”) controller may be implemented to synchronize the lighting elements 16 of the lighting system 1 to music or the like. Other controllers, as are known in the art, may be implemented to allow the lighting elements 16 of the lighting system 1 to execute a chasing lights pattern, to be dimmable and/or the like.

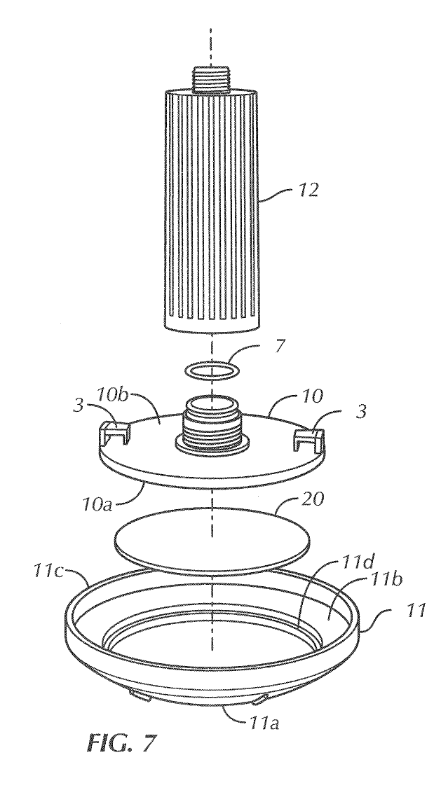

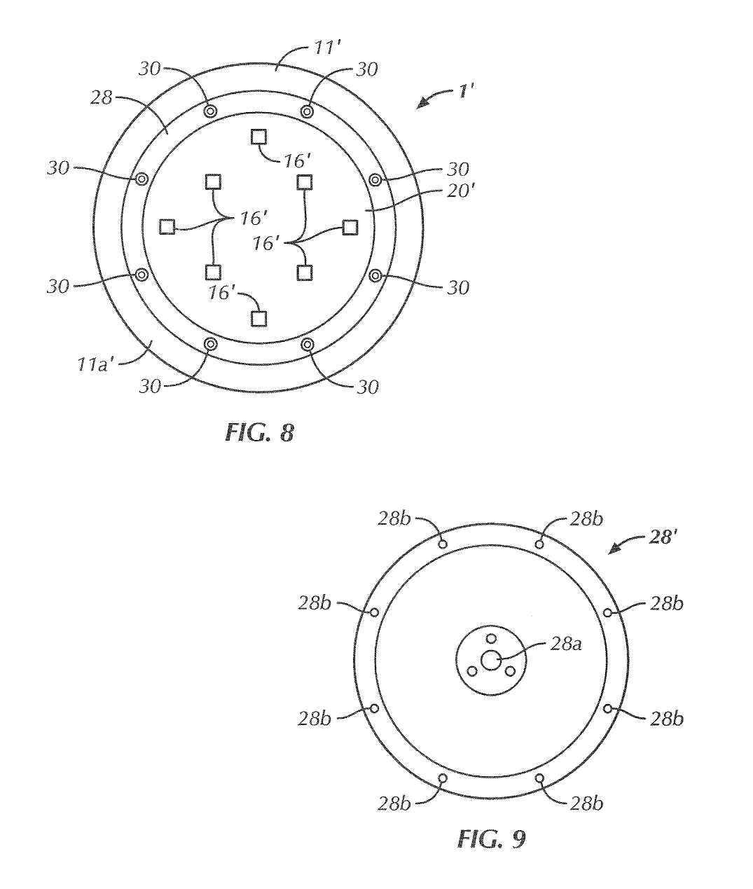

Referring to FIGS. 8 and 9, in a second preferred embodiment of the lighting system 1′ a heat dissipating plate 28 may be mounted to the lens 11′ to assist in dissipating heat from the circuit board 20′. The general components, construction and arrangement of the lighting system 1′ of the second preferred embodiment are generally the same or similar to the lighting system 1 of the first preferred embodiment and like reference numerals are utilized to identify like elements, with a prime symbol (′) utilized to distinguish the elements of the second preferred embodiment. The heat dissipating plate 28 may replace the base 10′, as is shown in FIGS. 8 and 9, or may be mounted to the second side 10b of the base 10 to assist in dissipating heat from the circuit board 20′. The heat dissipating plate 28 preferably includes a central hole 28a to accommodate the threaded coupling 13 extending from the second side 10b of the base 10. Alternatively, the heat dissipating plate 28 may include the threaded coupling (not shown) for mounting to the socket 12 and the snap connector members (not shown) for mounting to the adaptor 2.

In the second preferred embodiment, the heat dissipating plate 28 is mounted to the lens 11′ by eight (8) fasteners (not shown) that extend through eight (8) fastener holes 28b in the heat dissipating plate 28 and eight (8) complementary fastener fittings 30 extending through the lens 11′. The eight (8) fastener holes 28b and eight (8) fastener fittings 30 accommodate the eight (8) fasteners (not shown) to secure the heat dissipating plate 28 to the lens 11′ and promote dissipation of heat from the circuit board 20′ due to the high conductivity of the metallic heat dissipating plate 28. The circuit board 20′ of the second preferred embodiment is shown with eight (8) LEDs 16′ spaced on its external surface for illuminating the water 18 or landscaping, but is not so limited and may include nearly any number of LEDs 16′, depending upon designer or user preferences. The heat dissipating plate 28 is preferably secured in tight facing engagement with the base 10′ or is designed and configured to replace the base 10′ to facilitate heat dissipation from the circuit board 20′ to the water 18 in contact with the heat dissipating plate 28 in pool or spa configurations or to the air surrounding the heat dissipating plate 28 in landscape configurations. As in the first preferred embodiment, the flow of the water 18 in the pool around the lighting system 1′, which extends from the wall 26 of the pool, promoted dissipation of heat from the lighting system 1′ and the circuit board 20′ to limit malfunction of the lighting system 1′ due to overheating.

It will be appreciated by those skilled in the art that changes could be made to the embodiments described above without departing from the broad inventive concept thereof. For example, the materials of the lens 11, 11′, the base 10, the circuit board 20, 20′ or other components may be constructed of composite materials with heat conductive properties to further promote dissipation of heat from the circuit board 20 to limit overheating and malfunction of the preferred lighting systems 1, 1′. It is understood, therefore, that this invention is not limited to the particular embodiments disclosed, but it is intended to cover modifications within the spirit and scope of the present invention as defined by the appended claims.

We claim:

1. A lighting system for mounting to a fitting in a pool or to a landscape stake, the lighting system comprising:
a lens having an exterior side and an interior side;
a base having a first side and a second side, the base being sealingly coupled to the interior side of the lens to create a watertight compartment therebetween, the second side of the base having at least one connector member;
a circuit board coupled to the first side of the base, the circuit board implementing a circuit including a plurality of light emitting diodes (“LEDs”) and a power supply receiving connector, the power supply receiving connector being accessible through the second side of the base; and
an adaptor having a first side configured to interface with the at least one connector member and a second side having a threaded coupling to maintain the lighting system in a fixed position in the fitting, heat from the light emitting diodes being dissipated through the base and lens to a medium surrounding the lens and base.

2. The lighting system of claim 1, further comprising:
an elongated plastic socket having a first end and a second end, the first end of the elongated plastic socket configured to be threadably coupled with the second side of the base, wherein the base further comprises a threaded coupling for interfacing with the first end of the elongated plastic socket.

3. The lighting system of claim 2, wherein a watertight seal is formed when the elongated plastic socket and the base are coupled.

4. The lighting system of claim 3, wherein the elongated plastic socket is configured to receive a power supply cable at the second end and to output the power supply cable at the first end, the power supply cable having a DC jack connector configured to be operatively coupled to the power supply receiving connector.

5. The lighting system of claim 4, wherein the circuit is configured to be powered by a twelve (12) Volt power supply.

6. The lighting system of claim 1, wherein the circuit includes a microcontroller configured for executing one or more programs for activating and deactivating the plurality of LEDs.

7. The lighting system of claim 6, wherein the one or more programs are selected from a chasing lights program, a favorite color program, a random color pattern program and a music synchronization program.

8. The lighting system of claim 1, wherein the adaptor is configured to interface with the at least one connector member by at least one hook member.

9. The lighting system of claim 1, wherein the fitting is a standard one and one-half inch (1.5″) threaded pool fitting.

10. A heatsinkless lighting system for mounting to a standard pool fitting and being submerged in water, the heatsinkless lighting system comprising:
a curved lens having an exterior side and an interior side;
a base sealingly coupled to the interior side of the curved lens, the base having one or more connector members;
a circuit board coupled to the base such that the circuit board is sealed between the curved lens and the base, the circuit board implementing a circuit comprising a plurality of lighting elements spaced apart from one another on the circuit board to dissipate heat generated by operation of the plurality of lighting elements through the base and lens to the water; and
an adaptor configured to mount the heatsinkless lighting system to the standard pool fitting, the adaptor having one or more hook members configured to engage with the one or more connector members of the base.

11. The heatsinkless lighting system of claim 10, wherein the plurality of lighting elements are a plurality of LEDs.

12. The heatsinkless lighting system of claim 11, further comprising:
an elongated plastic socket having a first end and a second end, the first end of the elongated plastic socket configured to be threadably coupled with the base, wherein the base further comprises a threaded coupling for interfacing with the first end of the elongated plastic socket.

13. The heatsinkless lighting system of claim 12, further comprising:
a stake configured to be operatively coupled with the elongated plastic socket to maintain the heatsinkless lighting system in a fixed position in a surface, the stake being perpendicular to the surface, the plurality of lighting elements adapted to dissipate heat generated by operation of the plurality of lighting elements through the base and lens to air surrounding the lens and base.

14. The heatsinkless lighting system of claim 11, wherein the plurality of lighting elements is comprised of a layout of sixteen LEDs.

15. The heatsinkless lighting system of claim 11, the plurality of lighting elements is comprised of a layout twenty-four LEDs.

16. The heatsinkless lighting system of claim 11, wherein the adaptor further comprises a threaded coupling for threadably mounting the heatsinkless lighting system to the standard pool fitting, the standard pool fitting comprising a standard one and one-half inch (1.5″) threaded pool fitting.

17. The heatsinkless lighting system of claim 10, wherein the circuit includes a microcontroller storing one or more instructions for activating and deactivating the plurality of lighting elements.

18. The heatsinkless lighting system of claim 10, wherein the circuit is configured to be powered by a twelve Volt (12 V) power supply.

19. A heatsinkless lighting system for mounting to a standard pool fitting and being submerged in water, the heatsinkless lighting system comprising:
a curved lens having an exterior side and an interior side;
a base sealingly coupled to the interior side of the curved lens, the base having a first side and a second side, the second side of the base having two or more snap connector members and a threaded coupling arranged thereon;
a circuit board coupled to the first side of the base such that the circuit board is sealed between the curved lens and the base, the circuit board implementing a circuit comprising a plurality of lighting elements spaced apart from one another on the circuit board to dissipate heat generated by operation of the plurality of lighting elements through the base and lens to the water; and
an adaptor configured to mount the heatsinkless lighting system to the standard pool fitting, the adaptor having a hook member configured to engage with a snap connector member of the base.

20. The heatsinkless lighting system of claim 1, wherein the circuit implemented on the circuit board includes a power supply input pin that is accessible through a void in the middle of the threaded coupling in the second side of the base, wherein the threaded coupling engages with a plastic elongated socket housing a conductor with a DC jack connector therein.
